(19) United States
(12) Patent Application Publication
(10) Pub. No.: US 2005/0109051 A1
(43) Pub. Date: May 26, 2005

(54) Motor vehicle air-conditioning system having standstill air-conditioning

(75) Inventor: Dieter Heinle, Pludershausen (DE)

Correspondence Address: FOLEY AND LARDNER;SUITE 500, 3000 K STREET NW, WASHINGTON, DC, 20007, US

(73) Assignee: BEHR GmbH & CO. KG

(21) Appl. No.: 10/995,344

(22) Filed: Nov. 24, 2004

(30) Foreign Application Priority Data
Nov. 25, 2003 (DE) 103 55 397.5

(51) Int. Cl. F25B 27/00; B60H 1/32; F25B 43/00

(52) U.S. Cl. 62/236; 62/243; 62/323.3

(57) ABSTRACT

A motor vehicle air-conditioning system (1) has a standstill air-conditioning mode of operation for operating the motor vehicle air-conditioning system (1) in the event that the motor vehicle engine is at a standstill, using an auxiliary power supply (5). A generator (7) is provided which can be operated by means of the auxiliary power supply (5) when the motor vehicle engine is at a standstill and can alternately be operated as an electric motor (7′) in the event that a normal external electrical power supply (9) is available. A method for operating such a motor vehicle air-conditioning system (1) is also described.

### CROSS-REFERENCE TO RELATED PATENT APPLICATIONS

The right of foreign priority is claimed based upon Federal Republic of Germany Patent Application No. 103 55 386,5, filed Nov. 25, 2003, the entire disclosure of which, including the specification, drawings, claims and abstract, is incorporated herein by reference.

### BACKGROUND OF THE INVENTION

The invention relates to a motor vehicle air-conditioning system having a standstill air-conditioning mode of operation, for operating the motor vehicle air-conditioning system in the event that the motor vehicle engine is at a standstill, using an auxiliary power supply.

Air-conditioning systems having standstill air-conditioning are known which have a small diesel engine as the auxiliary drive. However, they are relatively loud and heavy.

In addition, it is known to use electrical compressors. However, they are expensive and are usually unsuitable for use in trucks owing to their operating life. Currently, the standstill air-conditioning is thus restricted purely to a heating mode, using standstill heating with a limited running time, since the battery is unsuitable for continuous operation.

### SUMMARY OF THE INVENTION

It is therefore one object of the present invention to provide an improved air-conditioning system having a standstill air-conditioning operating mode.

A further object of the invention is to provide a vehicle equipped with the improved air-conditioning system according to the invention.

In accomplishing the objects of the invention, there has been provided in accordance with one aspect of the invention a motor vehicle air-conditioning system having a standstill air-conditioning mode for operating the motor vehicle air-conditioning system in the event of the motor vehicle engine being at a standstill, comprising: an auxiliary power supply; and a generator connected to the auxiliary power supply, whereby the generator can be operated by means of the auxiliary power supply when the motor vehicle engine is at a standstill and can alternately be operated as an electric motor in the event that an external power supply is available.

In accordance with another aspect of the invention, there has been provided a motor vehicle embodying an air-conditioning system of the type defined above.

In accordance with yet another aspect of the invention, there has been provided a method for operating a motor vehicle air-conditioning system of the type that includes a standstill air-conditioning mode, comprising operating the standstill air-conditioning system either using the auxiliary power supply or using an external power supply.

Further objects, features and advantages of the invention will become apparent from the detailed description of preferred embodiments that follows, when considered together with the accompanying figures of drawing.

### BRIEF DESCRIPTION OF THE DRAWINGS

In the drawings:

FIG. 1 is a schematic, partial illustration of the air-conditioning system in the standstill mode of operation, with an APU driving a compressor, and

FIG. 2 is an illustration corresponding to that in FIG. 1, with the APU being inactive, and the standstill air-conditioning system being driven by means of an electric motor, driven by an external power supply.

### DETAILED DESCRIPTION OF THE PREFERRED EMBODIMENTS

The invention comprises a motor vehicle air-conditioning system having a standstill air-conditioning operating mode for operating the motor vehicle air-conditioning system using an auxiliary power supply, in the event of the motor vehicle engine is at a standstill. A generator is provided which can be operated by means of the auxiliary power supply when the motor vehicle engine is at a standstill and which can alternately be operated as an electric motor in the case that an external power supply is available. In the case of an external power supply, the electric motor drives the mechanical compressor coupled thereto. In this mode of operation, the auxiliary power supply is redundant, and the secondary units, such as the fan, are operated directly via the external power supply, with the use of a voltage converter.

When the power is supplied by means of the auxiliary power supply, this auxiliary power supply is used to drive the compressor. Owing to the presence of a voltage converter which is preferably provided directly after the introduction of the external power, the high AC voltage is converted to the lower vehicle power supply voltage, so as to reduce sources of danger.

The drive for the compressor can preferably be connected to the output drive for the electric motor, and, in this case, the auxiliary power supply, which is inactive, is preferably arranged between the two.

Turning now to the drawings, the figures show a motor vehicle air-conditioning system 1, of which only the mechanical compressor 2 is illustrated in the drawings. In terms of its power supply, the compressor 2 is connected to an auxiliary power supply, referred to as the APU 5 (auxiliary power unit) below, via a drive shaft 3 and a coupling 4, preferably a clutch. The APU 5 is for its part connected via a further shaft 6 to a generator 7, which can also be operated as an electric motor 7′.

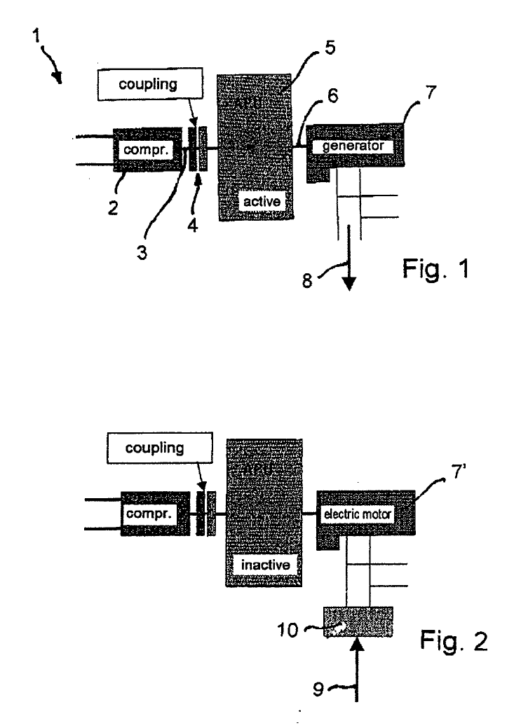

The APU 5 in this case acts as an emergency power supply which takes over the driving of the compressor 2 when the motor vehicle engine (not shown) is at a standstill, with the result that the air-conditioning system 1 can continue to operate (standstill air-conditioning). If no power is required by the compressor 2, the excess power from the APU 5 is supplied to the generator 7 via the shaft 6, and the generator 7 acts as a 12 V voltage source 8 in accordance with the present exemplary embodiment and charges, for example, a battery which stores the power (see FIG. 1). Alternatively, the excess power can be used for generating light or heating, for example.

If an external power supply 9 (ground power supply), in this case a 230 V AC source, is provided, as illustrated in FIG. 2, the electrical power is supplied to the generator 7, which is now acting as an electric motor 7′, via a voltage converter 10. If required, this generator 7 (acting as an electric motor 7′) drives the compressor 2 of the air-conditioning system 1 via the (in this case) inactive APU 5 so as to ensure the cooling function of said air-conditioning system 1 when at a standstill. The secondary units, such as the fan, are operated directly via the external power supply, with the voltage converter 10 being used to match the voltage and to convert the alternating current to a direct current. The converted power supplied by the external power supply 9 may also be used for heating purposes.

In accordance with an alternative embodiment, a belt drive is provided in place of the coupling 4, resulting in transmission ratios other than 1:1. Other connections are also possible.

The air-conditioning system referred to herein is to be understood as the conventional type of system, which typically includes a compressor, an expansion valve, an evaporator and a condenser in an air-conditioning circuit that contains a refrigerant. The evaporator of this circuit is typically positioned inside of the housing of a vehicle air-conditioning arrangement, through which air is transported by means of a blower, to be passed through the evaporator and selectively through one or more heaters, by means of an air control system typically employing a series of air control flaps or valves. Examples of these types of systems are disclosed, e.g., in commonly assigned U.S. Published Patent Application No. 2002/0014331 and U.S. Pat. No. 6,691,527, the entire disclosures of which are hereby incorporated by reference.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

1. A motor vehicle air-conditioning system having a standstill air-conditioning mode for operating the motor vehicle air-conditioning system in the event of the motor vehicle engine being at a standstill, comprising: an auxiliary power supply; and a generator connected to the auxiliary power supply, whereby the generator can be operated by means of the auxiliary power supply when the motor vehicle engine is at a standstill and can alternately be operated as an electric motor in the event that an external power supply is available.

2. A motor vehicle air-conditioning system according to claim 1, wherein the air-conditioning system also includes a mechanical compressor and a device for selectively driving the compressor by the electric motor operated by the external power supply and/or by the auxiliary power supply.

3. A motor vehicle air-conditioning system according to claim 2, wherein the driving device for the compressor comprises a device for selectively connecting the input drive of the compressor to the output drive for the electric motor.

4. A motor vehicle air-conditioning system according to claim 3, wherein the auxiliary power supply is arranged between the input drive for the compressor and the output drive for the electric motor.

5. A motor vehicle air-conditioning system according to claim 1, characterized in that the auxiliary power supply is inactive in the case of an external power supply.

6. A motor vehicle air-conditioning system according to claim 1, further comprising a voltage converter for the external power supply.

7. A motor vehicle air-conditioning system according to claim 6, wherein the voltage converter is connected adjacent to the external power supply.

8. A method for operating a motor vehicle air-conditioning system according to claim 1, comprising operating the standstill air-conditioning system either using the auxiliary power supply or using an external power supply.

9. A method according to claim 8, wherein, in the case of standstill air-conditioning using the external power supply, further comprising converting the voltage from the external power supply.

10. A method according to claim 8, comprising driving a mechanical compressor by either the auxiliary power supply or, in the event an external power supply is available, performing a voltage conversion of voltage from the external power supply and operating the generator as an electric motor to drive the compressor, while keeping the auxiliary power supply inactive.

11. A motor vehicle having an air-conditioning system, wherein the air-conditioning system comprises an air-conditioning system as defined by claim 1.
